(19) United States
(12) Patent Application Publication
(10) Pub. No.: US 2018/0259696 A1
(43) Pub. Date: Sep. 13, 2018

(54) PHOTOCHROMIC MULTI-PANE WINDOWS

(71) Applicant: Corning Incorporated, Corning, NY (US)

(72) Inventors: Nicholas Francis Borrelli, Elmira, NY (US); Nadja Teresia Lonnroth, Corning, NY (US); Michel Prassas, Fontainebleau (FR); Paul Michael Then, Victor, NY (US); Luis Alberto Zenteno, Painted Post, NY (US)

(73) Assignee: Corning Incorporated, Corning, NY (US)

(21) Appl. No.: 15/759,341

(22) PCT Filed: Sep. 8, 2016
(86) PCT No.: PCT/US2016/050746

§ 371 Date: Mar. 12, 2018

Related U.S. Application Data
(63) Continuation of application No. 15/259,572, filed on Sep. 8, 2016.
(60) Provisional application No. 62/286,659, filed on Jan. 25, 2016.
(60) Provisional application No. 62/279,153, filed on Jan. 15, 2016.
(60) Provisional application No. 62/127,123, filed on Mar. 2, 2015.

(51) Int. Cl. G02B 5/28; E06B 3/66; C03C 17/36; C03C 4/06; C03C 3/11; C03C 3/093

(52) U.S. Cl. CPC G02B 5/282; E06B 3/66; C03C 17/366; C03C 4/06; E06B 2009/2417; C03C 3/093; C03C 3/11

(57) ABSTRACT

A window is provided comprising an outside glass pane and an inside glass pane. The outside glass pane includes a low emissivity layer. The inside glass pane comprises a photochromic glass and is spaced apart from and disposed substantially parallel to the outside glass pane. The outside glass pane transmits light in the visible portion of the optical spectrum. The low emissivity layer of the outside glass pane blocks transmission of solar radiation in the IR and near-IR bands, and transmits solar radiation in an activation band of the photochromic glass to darken the photochromic glass and reduce visible light transmittance through the photochromic glass.

This application claims the benefit of priority under 35 U.S.C. § 120 of U.S. application Ser. No. 15/259,572 filed on Sep. 8, 2016 which claims the benefit of priority to U.S. Provisional Application No. 62/217,123 filed on Sep. 11, 2015. This application also claims the benefit of priority under 35 U.S.C. § 119 of U.S. Provisional Application Ser. No. 62/286,659 filed on Jan. 25, 2016 and U.S. Provisional Application Ser. No. 62/279,153 filed on Jan. 15, 2016, the contents of which are relied upon and incorporated herein by reference in their entirety.

### BACKGROUND

### Field

The present disclosure relates generally to photochromic multi-pane window assemblies and to structures incorporating such window assemblies. More particularly, the present disclosure relates to photochromic multi-pane window assemblies comprising one or more low emissivity layers incorporated therein.

### Technical Background

Conventional architectural windows are comprised of double-pane and triple-pane units. That is, these units have two or three spaced apart glass panes used to insulate the temperature inside a structure from the outdoor temperature. Without effective filtration of electromagnetic radiation transmittance there through, however, conventional windows may lack an element needed to more effectively insulate structures and to control light transmitted into structures.

Accordingly, a need exists for a multi-pane window that is capable of further limiting solar heat gain and adjusting visible light transmissivity.

### SUMMARY

The present disclosure provides a multi-pane window comprising a photochromic glass and a low emissivity layer. The low emissivity layer reflects and/or absorbs infrared wavelengths and transmits ultraviolet and visible wavelengths to darken the photochromic glass and vary visible light transmittance into the structure.

According to embodiments of the present disclosure, a window is provided comprising an outside glass pane and an inside glass pane. In embodiments, the outside glass pane includes a low emissivity layer. In embodiments, the inside glass pane comprises a photochromic glass. In embodiments, the inside glass pane is spaced apart from the outside glass pane. In embodiments, the low emissivity layer transmits solar radiation in an activation band to activate the photochromic glass and reduce visible light transmittance through the photochromic glass.

According to embodiments of the present disclosure, a window including an outside glass pane and an inside glass pane. In embodiments, the outside glass pane comprises a low emissivity layer. In embodiments, the inside glass comprises a photochromic glass. In embodiments, the inside glass pane is spaced apart from the outside glass pane. In embodiments, the low emissivity layer transmits solar radiation in an activation band of the photochromic glass which reduces visible light transmittance through the contacted photochromic glass.

According to embodiments of the present disclosure, a building including an opening with a window therein is disclosed. In embodiments, the window includes an external glass pane and an internal glass pane. In embodiments, the external glass pane comprises a low emissivity layer. In embodiments, the internal glass comprises a photochromic glass. In embodiments, the internal glass pane is spaced apart from the external glass pane. In embodiments, the low emissivity layer transmits an activation wavelength of the photochromic glass which reduces visible light transmittance through the contacted photochromic glass.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is a front view of a multi-pane window as seen from the outside of a structure according to one embodiment.

FIGS. 2-4 are cross-sectional views of the peripheral edge of a double-pane window, drawn along line 1-1 of FIG. 1, according to some examples.

FIG. 5 illustrates low emissivity layer transmission spectra;

FIGS. 6-7 are cross-sectional views of the peripheral edge of a triple-pane window, drawn along line 1-1 of FIG. 1, according to exemplary embodiments.

FIG. 8 is a plot of light transmittance (%) vs. time (minutes) for two tests of a 2 mm thick Photogray® Extra photochromic glass pane at two different temperatures.

FIG. 9 is a plot of light transmittance (%) vs. temperature (° C.) for five tests of a 2 mm thick Photogray® Extra photochromic glass pane at five different temperatures.

FIG. 10 is a plot of visible light transmittance (fraction) v. time (minutes) for 2 mm thick Photogray® Extra photochromic glass pane exposed to light internal to a structure.

FIG. 11 is a plot of light transmittance (%) vs. wavelength (nm) for a 1.5 mm thick Photogray® Thin & Dark photochromic glass pane.

FIG. 12 is a plot of light transmittance (%) vs. wavelength (nm) for a 2 mm thick Photogray® Extra photochromic glass pane.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

Conventional multi-pane windows may have a number of shortcomings. One potential shortcoming may be the transmittance of infrared (IR) and near infrared (NIR) solar light wavelengths into the structure which causes heat gain therein. Another potential shortcoming may be the inability to reduce visible light transmittance over time into the structure independent of the outdoor temperature, but instead dependent upon interaction with specific light wavelengths from outside.

Conventional multi-pane windows have sometimes included low emissivity layers on their glass panes to limit transmittance of different combinations of solar light wavelengths into the structure. Low emissivity layers may reflect and/or absorb infrared (IR) and near infrared (NIR) wavelengths from the solar electromagnetic spectrum. In some cases, reflection of IR and NIR wavelengths may be≥90% of those in the solar spectrum, or even≥95%. Absorption of IR and NIR wavelengths by low emissivity layers may be≤5% of those included in the solar spectrum, or even less≤1%. Thus, low emissivity layers may reduce solar heat gain across the window into the structure. Conventional low emissivity layers may also reflect and/or absorb visible light and ultraviolet (UV) wavelengths. The reflection of visible light by conventional low emissivity layers may cause distortion of outdoor colors as seen from indoors (e.g., a blue sky viewed through the low emissivity layer may appear grey or green). The fraction of wavelengths absorbed by the low emissivity layer sometimes generates heat on the glass pane which the low emissivity layer exists. Conventional windows including low emissivity layers are not able to reduce visible light transmittance into the structure over time depending on interaction with specific light wavelengths from outside. Instead, low emissivity layers transmit a constant fraction of visible light from the solar spectrum.

Conventional multi-pane windows have also sometimes included photochromic organic polymer films on glass panes in windows to reduce transmittance of visible light through the window. These solutions may have limitations in that organic polymer films either degrade or lose their photochromic function before the expiration of the window lifetime. For example, some photochromic organic polymer films degrade after 5 years whereas a multi-pane window sometimes has a useful lifetime of around 30 years. Accordingly, photochromic organic polymer films from conventional multi-pane windows are not in accordance with the present disclosure. That is, photochromic glass of the present disclosure does not include organic polymer films or organic polymer films on glass panes.

Other conventional windows have sometimes included photochromic glass materials as the outside pane of a window in an attempt to reduce transmittance of visible light through the window depending on solar light intensity. That is, conventional windows have attempted to use photochromic glass properties (i.e., photochromism or darkening) to reduce the fraction of visible light transmittance during times of high solar light intensity (e.g., sunny days, ≥100,000 lux, etc.) and maximize visible light transmittance during times of low solar light intensity (e.g., overcast, night, ≤25,000 lux, etc.). Again, however, conventional windows have included the photochromic glass on the pane exposed to the outside elements. Notably, conventional windows including photochromic glass on the outside pane have failed to effectively change or vary visible light transmittance through the window in response to interaction with specific light wavelengths from solar radiation. After all, the photochromic effect (sometimes called darkening) of photochromic glass is also responsive to temperatures changes. Specifically, higher temperatures (e.g., >26° C.) may lessen a photochromic glass' ability to darken (and thereby reduce visible light transmittance). Also, lower temperatures (e.g.,<20° C., or even<15° C). may slow the reversal of the photochromic effect in photochromic glass (i.e., the glass stays in a darkened state for a longer time). Thus, a photochromic glass pane immediately adjacent to and exposed to outside temperatures may have problems.

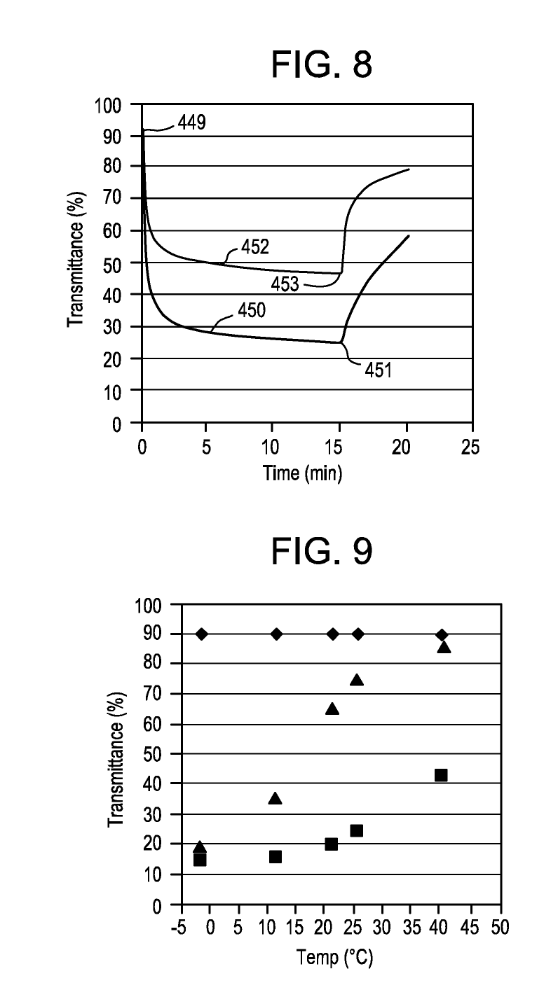

FIGS. 8 & 9 illustrate some possible problems associated with conventional multi-pane windows including photochromic glass windows as the outside pane. Both figures show that the change in visible light transmittance through photochromic glass exposed to solar light may be dependent, in part, on the temperature of the photochromic glass. Both also illustrate that the reversal rate of the photochromic effect when removed from solar light may depend on the temperature of the photochromic glass.

FIG. 8 provides a plot of light transmittance (%) vs. time (minutes) for a 2 mm thick Photogray® Extra glass pane in a solar simulator at two different temperatures. In both tests, the same Photogray® Extra glass pane has an original visible light transmissivity of about 90%. A simulated solar light was turned on at time t0 (indicated by point 449) in both tests. In the first test, indicated by line 450, the glass pane is kept at about 20° C. After 15 minutes (indicated by point 451), the photochromic effect (darkening) of the glass reduced the fraction of visible light transmissivity through the glass to about 28%. At point 451, the simulated solar light was turned OFF (deactivating the photochromism of the glass) which increased visible light transmissivity through the photochromic glass to about 59% after 5 minutes. In the second test, indicated by line 452, the glass pane is kept at 40° C. After 15 minutes (indicated by point 453), the darkening of the glass had reduced the fraction of visible light transmissivity through the glass to about 48%. At point 453, the light was turned OFF which increased visible light transmissivity through the photochromic glass 80% after 5 minutes. This illustrates one of the problems conventional windows may have when including the photochromic glass pane as the outside pane. For example, on hot days, when the sunlight is often at its most intense (e.g.,≥50,000 lux), the photochromic glass may be less effective (does not darken as much) at shielding the building inside from outside visible light.

Similarly, FIG. 9 provides a plot of light transmittance (%) vs. temperature (° C.) for a 2 mm thick Photogray® Extra photochromic glass pane tested at five different temperatures. Each test temperature includes three data points (one diamond, one square, and one triangle) with the temperature of the glass pane remaining constant during each test. In each test, the same Photogray® Extra photochromic glass pane started with a visible light transmissivity of about 90% (represented by the diamond data points). In each of the five tests, the pane was exposed to simulated solar light for 15 minutes and the visible light transmissivity was measured (represented by the square data points). The light was turned OFF to deactivate the photochromism and the visible light transmissivity was measured again after 5 minutes (represented by the triangle data points). FIG. 9 illustrates that as the temperature of a photochromic glass pane increases (e.g.,>26° C.), its photochromic capability may decrease. That is, a hotter photochromic glass pane may not darken as much so as to reduce the fraction of visible light transmissivity. Coincidently, hot, sunny days are a typical time when the darkening of photochromic glass would be most useful. FIG. 9 also illustrates that as the temperature of a photochromic glass pane decreases (e.g.,<20° C.), it may quickly darken in response to solar light but its capability to reverse from a darkened state may slow. That is, a colder photochromic glass pane may darken to limit transmissivity of visible light quickly, but may remain in that state for a longer time period. Also problematic, cold, overcast days (with periodic sun exposure) are a typical time when the rapid reversal of darkening of photochromic glass would be most useful. Thus, these examples illustrate that conventional window configurations including photochromic glass may not successfully control and vary visible light transmittance from solar radiation into the structure.

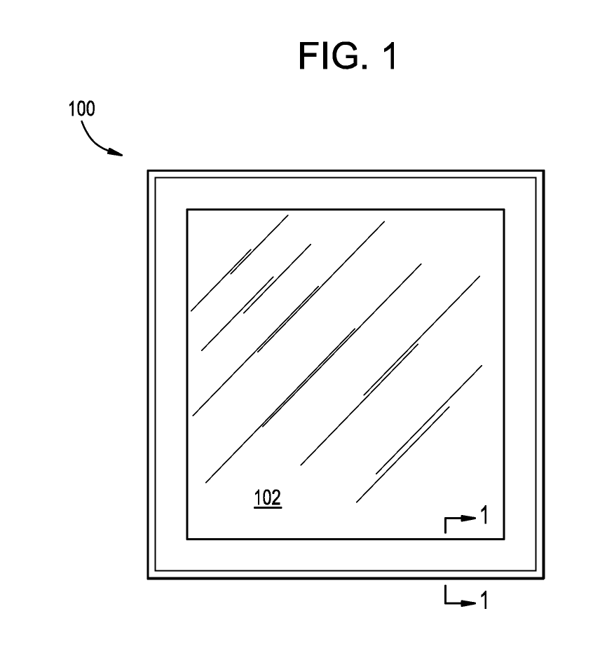

The present disclosure is directed to a multi-pane window 100 with a low emissivity layer and a photochromic glass. Window 100 may be an architectural window, for example. Accordingly, window 100 may be integral with an opening between the exterior and interior of an enclosure or building. Further, window 100 may be part of a door system on an enclosure or building. In embodiments, window 100 is movable with respect to an opening in a building. FIG. 1 provides an example of window 100. Of course, various dimensions and shapes of window 100 are possible and in accordance with the present disclosure. Window 100 shown in FIG. 1 may be a double pane or a triple pane window. Of course, window 100 may include any number of glass panes great than one pane. Window 100 may further include a spacer 421 between its panes. Spacer 421 may be an edge seal formed around respective edges of its glass panes, a metallic pillar between the surfaces of its glass panes, a low thermal conduction material, or a glass bump attached to or formed integral with one or both glass panes. Spacer 421 may assist in creating a space between its glass panes. Window 100 may further include a frame 420 around the edges of its glass panes.

In embodiments, frame 420 is configured to mate or communicate with an opening in a building or enclosure such that window 100 installed with inside glass pane 202 adjacent the building interior and outside glass pane 102 adjacent the building exterior. In embodiments, frame 420 includes an overhanging edge portion configured to interfere with an edge of an opening in a building or enclosure and to prevent window 100 from being installed in the opening such that outside glass pane 102 is adjacent the building interior. Window 100 may also include a locking mechanism adjacent inside glass pane 202 and internal to the building or enclosure. In embodiments, the locking mechanism is configured to be accessible only from the building interior so as to limit access through window 100. In embodiments, the locking mechanism is fixed directly or indirectly to frame 420 and communicates with a portion opening in the building or enclosure.

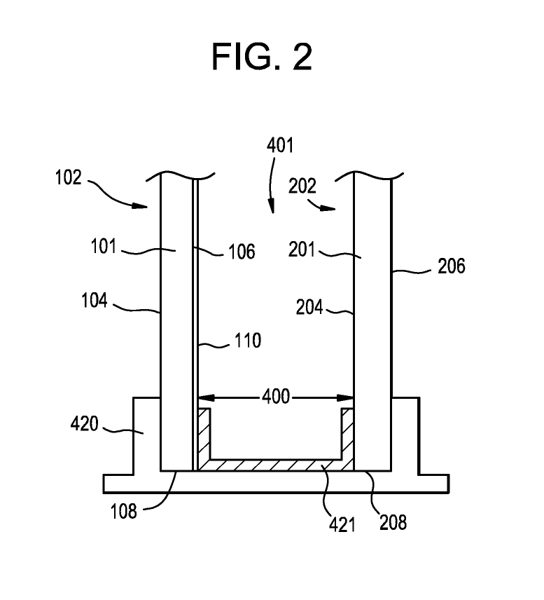

Referring to an example of a double pane embodiment of window 100 shown in FIG. 2 (a cross-section of a peripheral edge of window 100 in FIG. 1), window 100 includes an outside glass pane 102 and an inside glass pane 202 with a space 401 there between. Outside glass pane 102 and inside glass pane 202 face each other and are spaced apart from and disposed substantially parallel each other. Space 401 is defined at least in part by a distance 400 between pane 102 and 202. Distance 400 may be from about 50 microns to about 50 mm, or from about 5 mm to about 25 mm. Space 401 may be sealed and include an insulating gas such as air, argon, krypton, xenon, and combinations thereof. Alternatively, space 401 may be sealed and include a pressure less than atmospheric pressure. Inside and outside glass pane 202, 102 may also be configured as a vacuum insulated glass window as described in U.S. Pat. No. 8,821,999.

Exemplary glass panes (photochromic glass, non-photochromic glass, or otherwise) can have any suitable dimensions. Panes can have physical (length and width) dimensions that independently range from about 0.1 m to about 10 m (e.g., 2, 5, 10 m) and a thickness dimension that can range from about 0.1 mm to about 10 mm (e.g., 0.5, 1, 2, 5, 7 mm). Lateral dimensions and thicknesses of glass panes 102, 202, 302 in window 100 provide a rigid structure.

In embodiments, outside glass pane 102 is for interaction with outdoors. In embodiments, outside glass pane 102 is configured to be on the outside of an enclosure or adjacent a building exterior and exposed to weather, ambient conditions, and/or direct sunlight. Outside glass pane 102 may also be referred to as external glass pane 102 and/or exterior glass pane 102 herein. Inside glass pane 202 is for interaction with the indoors. That is, inside glass pane 202 is configured to be on the inside of an enclosure or building and exposed to conditions therein, including climate controlled conditions such as heating and/or air conditioning. Inside glass pane 202 may also be referred to as internal glass pane 202 and/or interior glass pane 202 herein.

In embodiments, outside glass pane 102 includes a body 101 with an outside surface 104 opposite an inside surface 106. In embodiments, outside surface 104 is directly exposed to the outdoors. In embodiments, inside surface 106 is adjacent space 401 between panes 102, 202. In embodiments, outside glass pane also includes at least one outer edge 108. In embodiments, outside glass pane 102 may include additional surfaces and/or edges. In embodiments, outside glass pane 102 is formed from a glass material and includes a low emissivity layer 110. Low emissivity layer 110 may be on surface 104, on surface 106, and/or at a location between surfaces 104 and 106. In one embodiment, shown in FIG. 2, low emissivity layer 110 is on surface 106 such that low emissivity layer 110 is shielded from weather and other outdoor elements. Yet in alternative embodiments, outside glass pane 102 may be entirely comprised of a low emissivity composition, in which case the low emissivity layer 110 would occupy the entire body 101 of the outside glass pane.

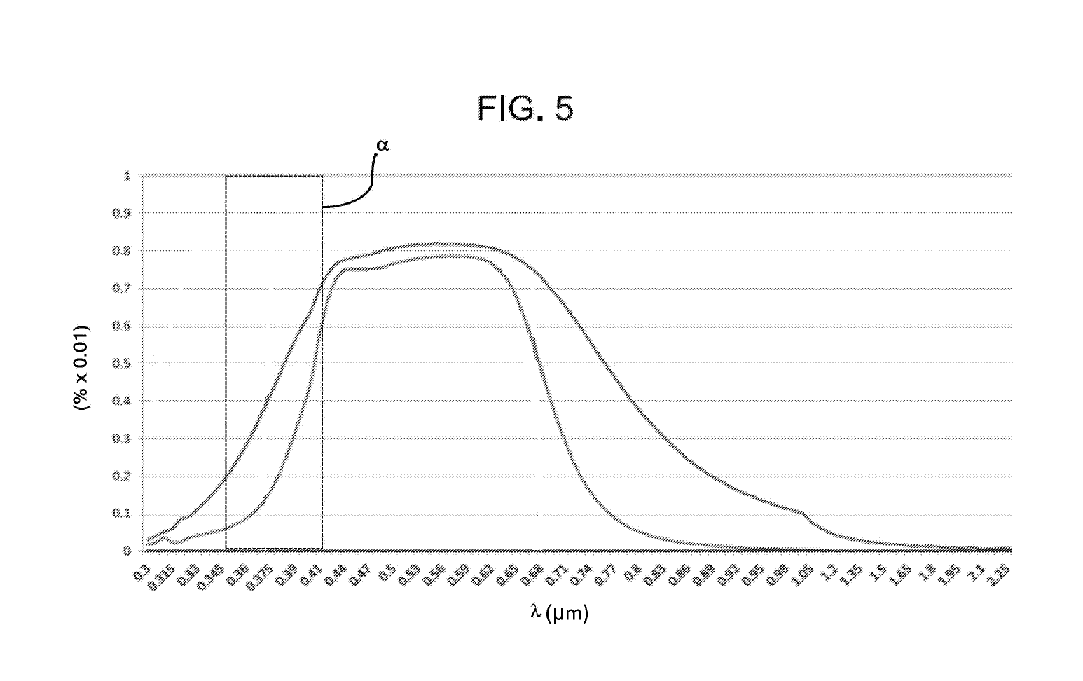

As is illustrated in FIG. 5, which illustrates the approximate transmission spectra of two of the many contemplated low emissivity layers according to the present disclosure, the low emissivity layer 110 selectively transmits light in different parts of the optical spectrum through optical absorption, reflection, or a combination thereof. Referring collectively to FIGS. 2 and 5, the low emissivity layer 110 selectively blocks transmission of IR and NIR wavelengths from the outdoors and, as such, minimizes heat transfer into space 401, onto inside glass pane 202, and/or across window 100 into the enclosure or building. This selective transmission may also reduce heat gain and transfer of heat to photochromic glass materials in the window 100.

More particularly, referring to the transmission spectra illustrated in FIG. 5, which correspond to double and triple layer silver low emissivity layers, low emissivity layers according to the present disclosure may be selected to comprise an infrared blocking threshold where the low emissivity layer blocks transmission of a portion of solar radiation in the IR and near-IR bands. For the purpose of the present disclosure, it is noted that low emissivity layers, which are commonly referred to as “Low-E” layers in the window industry, can be said to block a “significant” portion of IR and near-IR if they block enough IR and near-IR to be recognized in the industry as “Low-E” layers. In other embodiments, low-e layers block(s) a significant portion by reflecting and/or absorbing of at least about 50% or more of any individual wavelength in a band (e.g., IR, near-IR, etc.). In yet other embodiments, low-e layers block(s) a significant portion by reflecting and/or absorbing of at least about 50% or more of an average of all wavelengths in a band (e.g., IR, near-IR, etc.).

Each of the low emissivity layers illustrated in FIG. 5, for example, blocks a significant portion of wavelengths above about 700 nm, which corresponds to the start of the near-IR band. More particularly, at wavelengths above about 700 nm, the two low emissivity layers illustrated in FIG. 5 are less than about 70% and less than about 40% transmissive, respectively, and, more particularly, above about 2000 nm, both low emissivity layers are substantially non-transmissive. In particular embodiments, the aforementioned heat transfer can be sufficiently minimized by ensuring that the low emissivity layers according to the present disclosure, which are described in further detail below, will be selected such that they reach less than 10% transmittance at a wavelength from about 700 nm and about 2000 nm.

The glass material of outside glass pane 102 may be soda-lime glass, aluminosilicate glass, borosilicate glass, and/or combinations thereof. Visible light absorption and/or reflection by these the glass material of outside glass pane 102 may be negligible. The glass material of outside glass pane 102 is not photochromic glass. That is, outside glass pane 102 may include any substantially transparent, non- photochromic glass. Photochromic glass on outside pane 102 would be susceptible to the shortcomings of conventional windows including photochromic glass described above. Specifically, the photochromism of the photochromic glass may be partly dependent upon the temperature of the glass via heat transfer from outside ambient conditions. Thus, the various embodiments of the present disclosure may thermally isolate the photochromic glass from temperatures above or below room temperature, and yet still allow transmittance of specific wavelengths of light thereto to activate its photochromic properties.

Low emissivity layer 110 may be a film, a coating, or a layer on or within the glass material of outside glass pane 102, or may occupy the entire body 101 of the outside glass pane. Low emissivity layers of the present disclosure are not photochromic organic polymer films. Low emissivity layer 110 may be applied to or within outside glass pane 102 via magnetron sputtering vapor deposition (MSVD), pyrolysis, spraying, sputtering, and toher similar processes.

In an example embodiment, low emissivity layer 110 of outside glass pane 102 selectively reflects and/or absorbs near infrared (NIR) and/or infrared (IR) light from solar radiation (from outdoors). For example, low emissivity layer 110 reflects and/or absorbs light having a wavelength from about 700 nm to about 1 mm, or from about 701 nm to about 40,000 nm, or from about 701 to about 2,000 nm. Selective reflection may include reflection of≥80%, or even≥95%, of NIR and IR wavelengths interacting with low emissivity layer from outside solar radiation. With a low emissivity layer 110, outside glass pane 102 may transmit≤20%, or even≤5% of NIR and/or IR light contacting outside glass pane 102. Percent transmittance by outside glass pane 102 including layer 110 may be calculated using the ISO 9050: 2003 Standard (“Glass in building—Determination of light transmittance, solar direct transmittance, total solar energy transmittance, ultraviolet transmittance, and related glazing factors), for example. Alternatively, percent transmittance may be calculated by other standards and codes adopted by the International Code Council (ICC). Outside glass pane 102 with low emissivity layer 110 may have solar heat gain of≤60%, or even≤40% as a result of solar light contacting pane 102.

In one embodiment, low emissivity layer 110 transmits light in the visible spectrum. In embodiments, layer 110 transmits light having a wavelength from about 350 nm to about 700 nm, or transmits light having wavelength from about 390 nm to about 700 nm, or transmits light having wavelength from about 350 nm to about 420 nm. Light transmitted by low emissivity layer 110 within the above disclosed ranges may activate the photochromism of photochromic glass materials in window 100. Activation of the photochromism of photochromic glass materials according to the present disclosure may cause darkening of the glass, or a reduction in the fraction of visible light transmittance there through by 40% or more, or 50% or more, or 60% or more, or 70% or more, or 80% or more, up to 99%. In embodiments, low emissivity layer 110 of outside glass pane 102 may reflect and/or absorb UV light from about 100 nm to about 310 nm impinging thereon from outdoors.

Absorption and/or reflection of IR and NIR wavelengths from the outdoors by the low emissivity layer minimizes heat transfer into space 401, onto inside glass pane 202, and/or across window 100 into the enclosure or building. This absorption and/or reflection of IR and NIR wavelengths by layer 110 may also reduce heat gain and transfer of heat to photochromic glass materials. In one embodiment, low emissivity layer 110 may be configured to selectively transmit specific wavelengths through pane 102 for interaction with photochromic glass on panes 202, 302. In an example embodiment, the specific wavelengths may be from about 350 nm to about 700 nm, or from about 390 nm to about 700 nm, from about 350 nm to about 420 nm, or even from about 390 nm to about 420 nm. Interaction of these specific light wavelengths with the photochromic glass, at suitable intensities, and for a suitable duration, may activate and darken the photochromic glass. Darkened photochromic glass may have an about 50% or more decrease in the visible light transmittance there through. Despite its reflective and absorptive properties, low emissivity layer 110 of pane 102 may transmit some non-visible wavelengths of electromagnetic radiation impinging thereon. In one embodiment, low emissivity layer 110 of pane 102 transmits≥50% of visible light wavelengths from outside solar radiation, or≥60%, or≥70%, or even≥95%.

Low emissivity layer 110 may have an average thickness from about 1 nm to about 500 nm on the surface of a pane of window 100. Low emissivity layer 110 may be comprised of several layers to create a total thickness. The layers may be disposed adjacent to one another. In alternative embodiments, low emissivity layer 110 may be comprised of several layers spaced apart that cumulatively form the total thickness. In exemplary embodiments, low emissivity layer has a thickness from about 50 nm to about 250 nm, or even from about 100 nm to about 150 nm.

Low emissivity layer 110 may also be a coating formed from a plurality of layers. For example, the low emissivity coating may include an infrared- reflecting layer and one or more transparent inorganic layers. The infrared-reflecting layer and one or more transparent inorganic layers may be arranged in any configuration including several alternative layers of each. The infrared-reflecting layer may include a conductive metal such as silver, gold, copper, and combinations thereof, that reduces the transmission of heat through the coated pane. The inorganic layer within the low emissivity coating can be used to reflect near-infrared and infrared light and to control other properties and characteristics of the coating, such as color and durability. Inorganic materials include metal oxides including oxides of zinc, tin, aluminum, indium, bismuth, and titanium, among others. The inorganic layer of low emissivity layer 110 may include SiO₂, Al₂O₃, ZnO, TiO₂, SnO₂, and combinations thereof. In an exemplary embodiment, the top of low emissivity layer 110 may include a durability composition including oxides of silicon, aluminum (e.g., SiO₂ and Al₂O₃), and combinations thereof.

In window 100, panes including low emissivity layer according to embodiments may be SUNGATE® or SOLARBAN® low emissivity glass family products by PPG Industries; SUNGARD® low emissivity glass family products from Guardian; SOLAR-E® low emissivity glass family products from Pilkington-NSG; or PLANIBEL™ or COMFORT-AC™ low emissivity glass family products from Asahi Glass Company. In embodiments, low emissivity layer 110 comprises metallic silver, metallic nickel, silicon nitride, zirconium oxide, tin oxide, zinc oxide, and/or combinations thereof. Tin oxides include but are not limited to indium tin oxide and fluorine doped tin oxide.

Low emissivity layers of the present disclosure may be selected based on the photochromic properties of the photochromic glass such that the photochromic glass is activated (darkened) by specific light wavelengths transmitted by the low emissivity layer. For example, where the photochromic glass darkens upon exposure to light within a given activation band a, e.g., from about 350 nm and about 420 nm, the low emissivity layer may be selected such that it comprises a photochromic activation threshold, where the low emissivity layer transmits enough solar radiation in an activation band of the photochromic glass to enable solar radiation transmitted by the low emissivity layer of the outside glass pane in the direction of the inside glass pane to darken the photochromic glass and reduce visible light transmittance through the photochromic glass. In embodiments, activation band a includes any combination of activation wavelengths which reduce visible light transmittance through the photochromic glass. In embodiments, activation band a activates the photochromic effect of photochromic glass.

For surface sources, brightness can be approximated by luminance (measured in cd/m²). However, due to the lack of a formal standardized definition of the term brightness, it is frequently avoided in technical publications. For the purposes of the present disclosure it is noted that reference herein to the darkening of the photochromic glass and the reduction of visible light transmittance through the photochromic glass should be understood to denote a readily recognizable change in the degree of humanly visible light passed by the glass, with the understanding that the aforementioned darkening, or reduction of light transmittance, would occur over a correspondingly recognizable amount of time, i.e., a duration on the order of a number of seconds or minutes, but not hours, and typically under direct, or nearly direct, sunlight. For example, in some embodiments, the aforementioned darkening effect would be achieved in less than about 7 minutes, in other embodiments, the darkening effect would be achieved much more quickly, i.e., in less than a few seconds. In embodiments, the photochromic glass reduces visible light transmission there through when exposed to or contacted by an activation wavelength or band from at least 1 second to about 7 minutes.

More specifically, referring to the low emissivity layer transmission spectra illustrated in FIG. 5, which corresponds to double and triple layer silver low emissivity layers, each of these low emissivity layers transmits solar radiation at wavelengths from about 350 nm and about 420 nm, which corresponds to the activation band a of the photochromic glass. More particularly, the illustrated low emissivity layers are at least about 30% transmissive to wavelengths above about 370 nm and 390 nm, respectively, and, more particularly, are at least about 50% transmissive to wavelengths above about 385 nm and 410 nm, respectively.

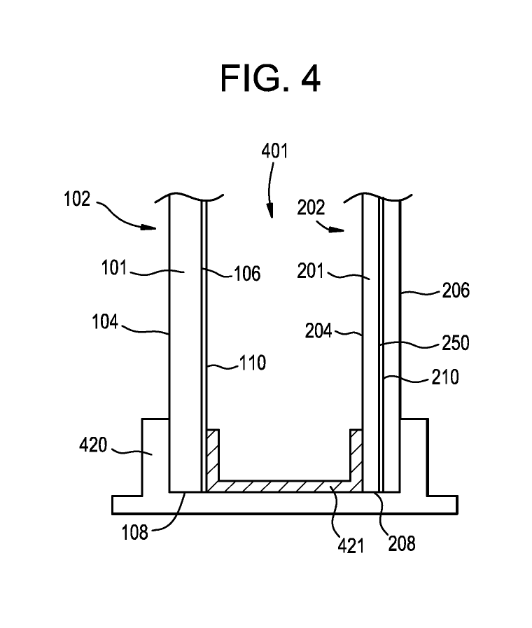

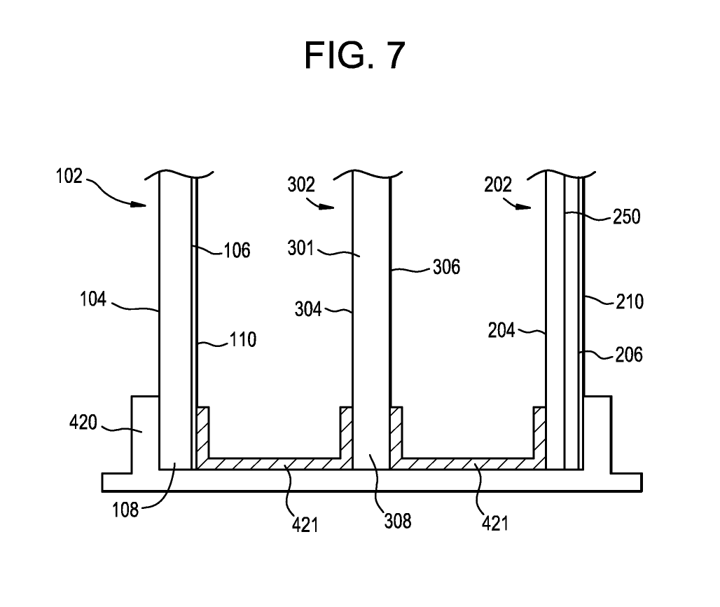

It is noted that the aforementioned selection criteria will typically only be applicable to low emissivity layers that are positioned between the source of outside solar radiation, i.e., the sun, and the photochromic glass. Where other low emissivity layers are utilized in other parts of a window assembly according to the present disclosure, for example, as part of an inside glass pane, as is illustrated in FIGS. 4 and 7, below, it will not typically be necessary, or particularly useful, to ensure that the wavelengths transmitted by the low emissivity layer activate the photochromic glass. In which case, where window assemblies constructed according to the concepts of the present disclosure incorporate low emissivity layers on opposite sides of the photochromic glass, as is the case in the embodiments of FIGS. 4 and 7, which are discussed in detail below, it may be preferable to select low emissivity layers with substantially different transmission characteristics. For example, it may be advantageous to ensure that any low emissivity layer disposed between the photochromic glass of the window assembly and an interior source of light, be selected to minimize transmittance of any wavelengths within the activation band a of the photochromic glass, as this would help ensure that the photochromic glass would not to react photochromically to inside light.

In embodiments such as FIG. 2, inside glass pane 202 includes a body 201 with an outside surface 204 opposite an inside 206. In embodiments, surface 206 is directly exposed to the indoors or is adjacent a building interior. In embodiments, surface 204 is adjacent space 401 between panes 102, 202. In embodiments, inside glass pane 202 also includes at least a first outer edge 208. In embodiments, inside glass pane 202 may include additional surfaces and/or edges. In embodiments, inside glass pane 202 may be formed in whole or in part from a photochromic glass material. That is, inside glass pane 202 may be a photochromic monolith or a glass laminate including a photochromic glass material. With inside glass pane 202 comprising the photochromic glass, the photochromic glass may be insulated from hot (e.g.,≥35° C.) and cold (e.g.,≤15° C.) outdoor temperatures that undesirably impact the photochromic effect as described above. In embodiments of the present disclosure, photochromic glass of glass pane 202 may be insulated from the outside ambient temperatures by glass pane 102, low emissivity layer 110, and/or space 401. In one embodiment, the photochromic glass of inside glass pane 202 is exposed to room temperature (e.g., about 20° C. to about 26° C.) conditions inside the structure.

In embodiments, photochromic glass of the present disclosure is an amorphous solid inorganic material. In embodiments, photochromic glass of the present disclosure may be substantially transparent when exposed only to visible light wavelengths. Photochromic glass of the present disclosure is configured to reversibly darken when exposed to activation wavelengths of solar light. Photochromic glass compositions of the present disclosure may comprise, in terms of weight percent (wt. %): SiO₂ 54-66; Al₂O₃ 7-15; B₂O₃ 10-25; Li₂O 0.5-4; Na₂O 1-15; K₂O 0-12; ZrO₂ 0-6; TiO₂ 0-3; PbO 0-1; Ag 0.1-1; Cl 0.1-1; Br 0-3; CuO 0.006-0.02; Sb₂O₃ 0-0.2; SnO₂ 0-0.2; CeO₂ 0-2.5; and F 0-2.5. In another embodiment, the photochromic glass may include, in terms of weight percent: SiO₂ 55-57; Al₂O₃ 6-7; B₂O₃ 18-19; Li₂O 1-2; Na₂O 1-5; K₂O 5-6; ZrO₂ 4-6; TiO₂ 2-3; Ag 0-0.5; CuO 0-1; Cl 0-1; and Br 0-1. In yet another embodiment, the photochromic glass may include, in terms of weight percent: SiO₂ 54-57; Al₂O₃ 6-8; B₂O₃ 19-21; Li₂O 3-5; Na₂O 0-2; K₂O 5-7; ZrO₂ 3-5; TiO₂ 0-2; PbO 0-1; Ag 0-1; Cl 0-1; Br 0-1; CuO 0-1; and Sb₂O₃ 0-1. In yet another embodiment, the photochromic glass may include, in terms of weight percent: SiO₂ 58-61; Al₂O₃ 8-11; B₂O₃ 18-21; Li₂O 1-3; Na₂O 0-4; K₂O 5-7; PbO 0-1; AgO 0-1; Cl 0-1; Br 0-1; and CuO 0-1. In yet another embodiment, the photochromic glass may include, in terms of weight percent: SiO₂ 51-66; B₂O₃ 15-23; Al₂O₃ 3-10; ZrO₂ 2.5-11; TiO₂ 0-1; Li₂O 3-7; Na₂O 0-8; K₂O 2-9; Ag 0.080-0.30; CuO 0.002-0.013; Cl 0.1-0.6; Br 0.040-0.3; MgO 0-3; CaO 0-3; SrO 0-3; BaO 0-3; Nb₂O₅ 0-1; La₂O₃ 0-8; and Y₂O₃ 0-8.

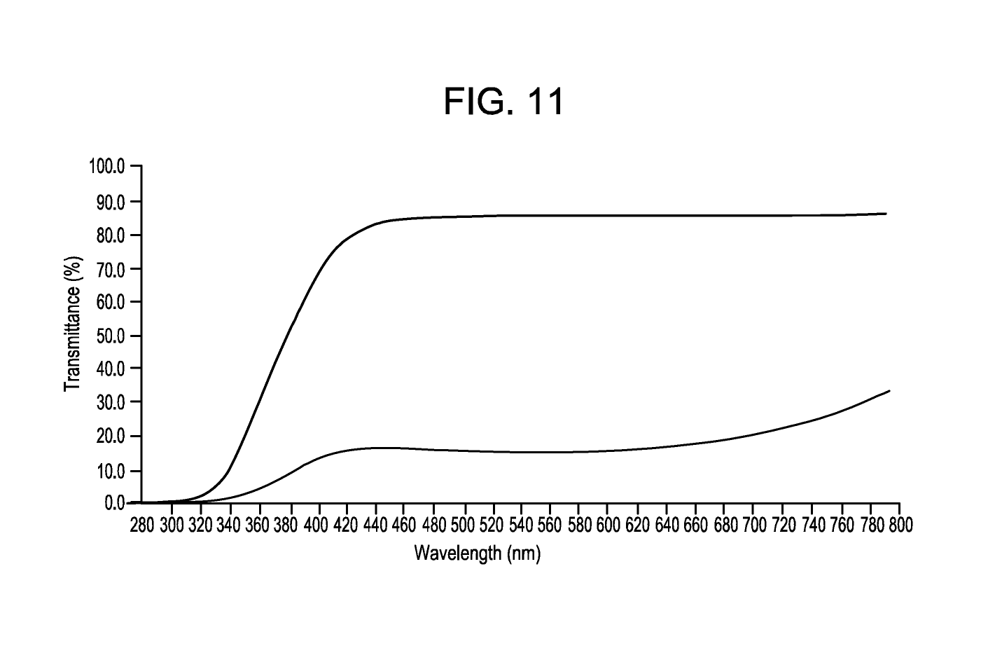

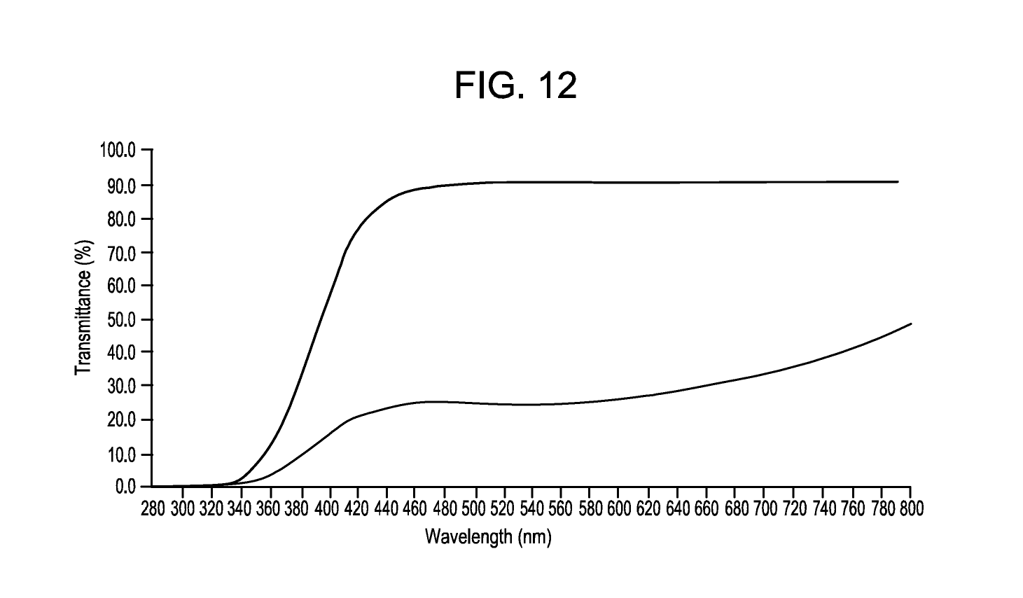

In alternative embodiments, the photochromic glass is Photogray® Extra, Photogray® Thin & Dark, or Photobrown® Extra by Corning Incorporated. FIG. 11 provides the percent transmittance for Photogray® Thin & Dark (1.5 mm thickness at 22° C.) as a function of wavelength (nm) exposure at a faded state (top line) and at a darkened state (bottom line). FIG. 12 provides the percent transmittance for Photogray® Extra (2 mm thickness at 22° C.) as a function of wavelength (nm) exposure at a faded state (top line) and at a darkened state (bottom line). The thickness of photochromic glass (e.g., the photochromic portion of a laminated glass pane) of the present disclosure may be from about 1 mm to about 6 mm, or from about 2 mm to about 4 mm, or even from about 1 mm to about 1.5 mm. In alternative embodiments, the photochromic thickness in a glass pane of window 100 may be a single thickness or a combination of thicknesses in one or more photochromic glass panes laminated directly or indirectly together. Photochromic glass of the present disclosure may be selected based on the properties of the low emissivity layer such that the photochromic glass is activated (darkened) by specific light wavelength transmitted by the low emissivity layer. Photochromic glasses of the present disclosure are not and do not include photochromic organic polymers.

Further teachings on available photochromic glasses, and their methods of production, may be gleaned from U.S. Pat. No. 3,406,085 (PHOTOCHROMIC WINDOW), U.S. Pat. No. 4,018,965 (PHOTOCHROMIC SHEET GLASS COMPOSITIONS AND ARTICLES), U.S. Pat. No. 4,148,661 (PHOTOCHROMIC SHEET GLASS COMPOSITIONS AND METHOD), U.S. Pat. No. 4,168,339 (PHOTOCHROMIC MICROSHEET), U.S. Pat. No. 4,190,451 (PHOTOCHROMIC GLASS), U.S. Pat. No. 4,204,027 (PHOTOCHROMIC SHEET GLASS PROCESS), U.S. Pat. No. 6,094,290 (LIGHT-REACTIVE THERMAL WINDOW), U.S. Pat. No. 8,713,972 (PRECISION GLASS ROLL FORMING PROCESS AND APPARATUS), U.S. Pat. No. 9,003,835 (PRECISION ROLL FORMING OF TEXTURED SHEET GLASS), and U.S. Pat. No. 9,145,330 (PHOTOCHROMIC GLASSES), the respective disclosures of which are incorporated herein by reference. Any inconsistencies between the disclosures of these references and the remaining disclosure of this document should be resolved in favor of the disclosure of this document as if the inconsistent teaching had not been incorporated herein by reference.

Photochromic glass of the present disclosure may be activated by solar light transmitted through outside glass pane 102 (e.g., soda-lime glass, aluminosilicate glass, borosilicate glass, etc.) including layer 110. Photochromic glass of the present disclosure is passive (reactive to contact with solar output wavelengths) not require electricity for activation. That is, photochromic glass is characterized in that its optical transmittance decreases when exposed to actinic radiation or activation wavelengths but which returns to its original transmittance state upon elimination of this radiation. Photochromic glass of the present disclosure may be activated by visible solar light wavelengths transmitted through layer 110 on a glass pane. In embodiments, photochromic glass of the present disclosure is activated by light transmitted by layer 110 which may be any visible wavelength, may have any wavelength from about 350 nm to about 700 nm, or from about 390 nm to about 700 nm, or even from about 350 nm to about 420 nm. In embodiments, photochromic glass of the present disclosure is activated by actinic wavelengths or activation bands of wavelengths transmitted by outside glass pane 102 including layer 110. In an exemplary embodiment, photochromic glass exposed to solar light transmitted by layer 110 darkens to a level to reduce visible light transmittance there through by at least about 40%, or by about 50%, or by about 60%, or even by about 75%. In another exemplary embodiment, specific light wavelengths (e.g., from about 350 nm to about 700 nm) transmitted by layer 110 interacts with photochromic glass and darkens it to a level to reduce light transmittance there through by at least about 50%, or by about 60%, or even by about 75%. When darkened, photochromic glass of the present disclosure may transmit≥10% of visible light that contacts outside glass pane 102. In another embodiment, darkened photochromic glass may transmit≤50%, or even≤35%, of visible light that contacts outside glass pane 102. Percent transmittance by the photochromic glass may be calculated using the ISO 9050: 2003 Standard, for example. Alternatively, percent transmittance may be calculated by other standards and codes adopted by the International Code Council (ICC).

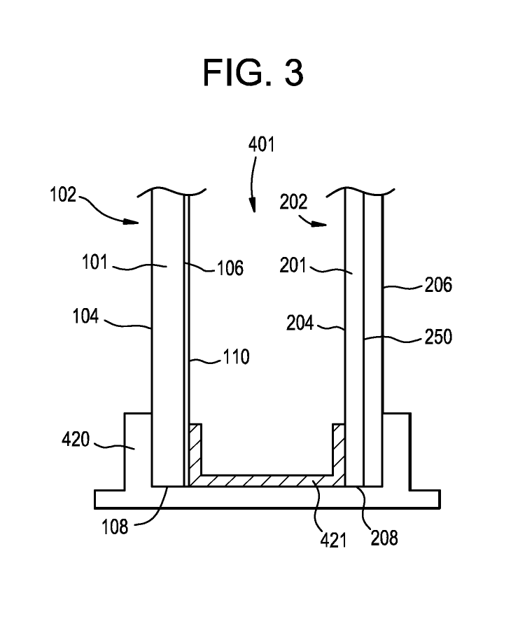

FIG. 3 illustrates an example embodiment of window 100 where pane 202 is a laminate of a non-photochromic glass and a photochromic glass with an interface 250 there between. In embodiments, one surface of inside glass pane 202 is formed from non-photochromic glass and the opposite surface is formed from photochromic glass. In embodiments, interface 250 is between the laminate components. Interface 250 is the area of transition within inside glass pane 202 from the non-photochromic glass material to the photochromic glass material. A bonding interlayer, which is substantially transparent to visible light, may be provided at the laminate interface 250. For example, and not by way of limitation, the boding interlayer may include a polymer. Bonding interlayer may include polyvinyl butyral (PVB), polycarbonate, acoustic PVB, ethylene vinyl acetate (EVA), thermoplastic polyurethane (TPU), an ionomer, a thermoplastic material, and/or combinations thereof. The non-photochromic glass material of inside glass pane 202 may be soda-lime glass, aluminosilicate glass, or borosilicate glass. In this embodiment, the laminate structure may provide strength to a thinner (e.g., 3 mm) photochromic glass. Non-photochromic glass materials of the present disclosure may be soda-lime glass, aluminosilicate glass, borosilicate glass, and/or combinations thereof.

FIG. 4 illustrates another embodiment of window 100 where a low emissivity layer 210 is provided at interface 250, between the non-photochromic glass and photochromic glass laminate in pane 202. In another embodiment, low emissivity layer 210 could be provided in any area across the thickness of glass pane 202, including on surface 206. Low emissivity layer 210 at interface 250 may further assist as an insulting layer within pane 202 (for the photochromic glass from both inside and outside temperatures) as described above. In embodiments, one or both of surfaces 204, 206 of glass pane 202 may be formed from photochromic glass. One of surfaces 204, 206 may also be formed from non-photochromic glass, such as a soda-lime glass composition. Low emissivity layer 210 at interface 250 on glass pane 202 may be the same or different layer 110 on glass pane 102.

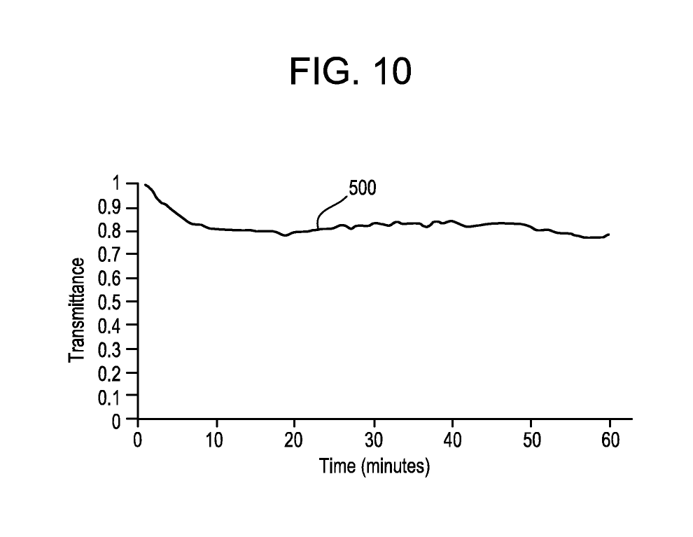

In one embodiment where surface 204 of pane 202 is formed from photochromic glass and surface 206 of pane 202 is formed from a non-photochromic (with interface 250 there between), low emissivity layer 210 provided at interface 250 could be different than that low emissivity layer 110. Specifically, layer 210 may be a UV blocking layer capable of selectively reflecting and/or absorbing UV wavelengths from inside the structure that may activate the photochromism (darkening) of photochromic glass formed as surface 204 of pane 202. The desire to filter UV light from inside the structure is illustrated in FIG. 10.

FIG. 10 provides a transmittance test of a Photogray® Extra photochromic glass pane exposed to internal building light, not external, outdoor light. The transmittance plot (illustrated by line 500) shows that the photochromic pane reduces visible light transmittance there through by about 20% after about 5 minutes of exposure to internal light. That is, internal light reduces visible light transmittance through photochromic glass from total visible light transmittance (i.e., 1) to about 0.8 visible light transmittance. When installed in a building or enclosure, background photochromic fading may be caused by UV light originating from inside light. Thus, a layer capable of minimizing transmittance of UV wavelengths to the photochromic glass in pane 202 (as shown in FIG. 4 or FIG. 7) could assist the photochromic glass not to react photochromically (darken) in response to inside light. Instead, photochromic glass formed as surface 204 would only react to transmitted outside ambient light. A low emissivity layer 210 on surface 206 could be formed at interface 250 (as shown in FIG. 4) or on surface 206.

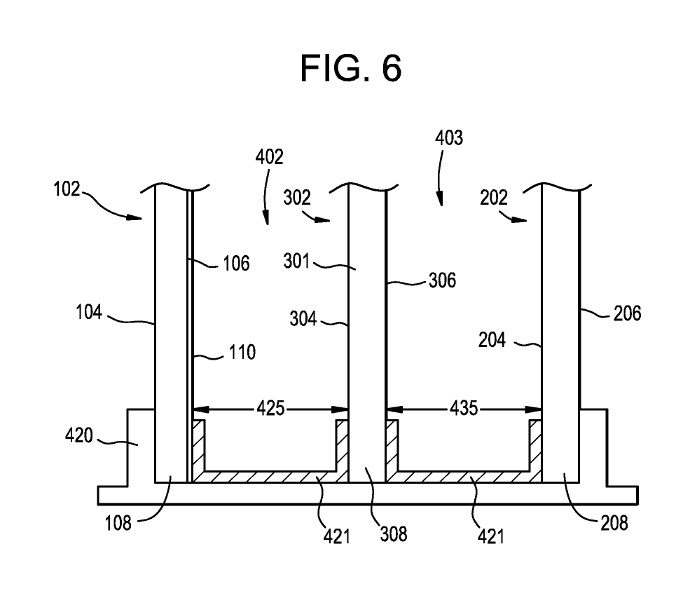

In the FIG. 6 embodiment, a third glass pane 302 may be within space 401 between glass panes 102 and 202. In embodiments, glass pane 302 includes a body 301 with an outside surface 304 opposite an inside surface 306. Glass pane 302 may be in space 401 between panes 102, 202. In embodiments, a space 402 may exist between panes 102, 302 and a space 403 may exist between panes 302, 202. In embodiments, glass pane 302 is spaced apart from and disposed substantially parallel to glass panes 102, 202. Space 402 may be defined in part by a distance 425 between pane 102 and 302. Space 403 may be defined in part by a distance 435 between pane 302 and 202. Spaces 402, 403 may include a spacer 421. Distances 425, 435 may be the same or different than distance 400. One or both of spaces 402, 403 may be sealed and include an insulating gas like air, argon, krypton, and xenon. Alternatively, one or both of spaces 402, 403 may be sealed and include a pressure less than atmospheric pressure. In embodiments, outside surface 304 of pane 302 is adjacent space 402 between panes 102, 302. In embodiments, inside surface 306 is adjacent space 403 between panes 302, 202. In embodiments, glass pane 302 also includes at least one outer edge 308. Glass pane 302 may include additional surfaces and/or edges. Glass pane 302 may be formed from soda-lime glass, aluminosilicate glass, borosilicate glass, and/or combinations thereof.

Glass pane 302 may also include a low emissivity layer (not shown in FIGS. 6 and 7). Low emissivity layer 310 may be on surface 304, on surface 306, and/or at a location there between. Low emissivity layer 310 may be the same as or different from low emissivity layer 110, 210. Glass pane 302 may also be formed from photochromic glass compositions. Glass pane 302 may also be formed from a non-photochromic glass and a photochromic glass as laminate with an interface there between. That is, one surface of glass pane 302 is formed from non-photochromic glass and the opposite surface is formed from photochromic glass. In another embodiment of window 100, low emissivity layer 310 is provided at the interface, between the non-photochromic glass and photochromic glass laminate in pane 302. In another embodiment, low emissivity layer could be provided in any area across the thickness of glass pane 302. Of course, the interface of a laminated glass pane 302 may include a bonding interlayer.

Glass pane 302 in window 100 may help to further insulate photochromic glass of glass pane 202 from the outside ambient temperatures. Alternatively, glass pane 302 may include photochromic glass, non-photochromic glass, and/or a low emissivity composition, each independent or any combination of the three as a laminate. In the FIG. 7 embodiment, pane 202 is a laminate of a photochromic glass, a soda-lime glass, and a low emissivity layer. The photochromic glass forms surface 204 and the soda-lime glass forms surface 206 with low emissivity layer 210 thereon. This embodiment may provide a window solution for particularly hot and/or cold climates. Accordingly, photochromic glass forming surface 204 is insulated from outside temperatures by glass panes 108, 308, low emissivity layer 110, and spaces 402, 403. For cold climates, low emissivity layer 210 may reflect inside heat back inside or may act as a UV blocking layer capable of selectively reflecting and/or absorbing UV wavelengths from inside the structure.

As is noted above, low emissivity layers utilized in accordance with the concepts of the present disclosure may absorb a portion of the infrared (IR) and near infrared (NIR) wavelengths from the solar electromagnetic spectrum and, as such, may become heated upon exposure. In the embodiments illustrated in FIGS. 2, 3, 4, 6 and 7, and in other window assemblies constructed according to the concepts of the present disclosure, where a low emissivity layer 110 is provided on a glass pane in one of the thermally insulating spaces 401, 402, 403 between respective photochromic and non-photochromic glass panes, the low emissivity layer is only provided on the glass pane that is non-photochromic. In this manner, the photochromic glass pane will be thermally insulated from the low emissivity layer by the evacuated space between the panes, or by the thermally insulating gas provided there between, and will not be subject to any undue performance degradation that might otherwise be attributable to heating of the photochromic material by direct thermal contact with the low emissivity layer. In exemplary embodiments, the photochromic glass of the inside pane is insulated from temperatures below 15° C. and above 26° C.

In embodiments, any one or combination of glass panes 102, 202, 302 (or layers therein) may include a thermally strengthened glass layer, a chemically strengthened glass layer, a mechanically strengthened glass layer, a thermally and chemically strengthened glass layer, a thermally and mechanically strengthened glass layer or a chemically and mechanically strengthened glass layer. In embodiments, the photochromic glass is thermally strengthened glass, or chemically strengthened glass, or mechanically strengthened glass, or thermally and chemically strengthened glass, or thermally and mechanically strengthened glass, or chemically and mechanically strengthened glass. In an embodiment where the photochromic glass of internal glass pane 202 is laminated to a non-photochromic glass, the non-photochromic glass may be thermally strengthened glass, or chemically strengthened glass, or mechanically strengthened glass, or thermally and chemically strengthened glass, or thermally and mechanically strengthened glass, or chemically and mechanically strengthened glass. Of course the photochromic glass and non-photochromic glass may be different combinations of the above strengthening techniques to create the same or different strength profiles on opposite sides of the interface.

According to one embodiment of the present disclosure, a window is provided comprising an outside glass pane and an inside glass pane. In embodiments, the outside glass pane includes a low emissivity layer. In embodiments, the inside glass pane comprises a photochromic glass and is spaced apart from and disposed substantially parallel to the outside glass pane. In embodiments, the outside glass pane transmits light in the visible portion of the optical spectrum and its low emissivity layer comprises an infrared blocking threshold where the low emissivity layer blocks transmission of a significant portion of solar radiation in the IR and near-IR bands. In embodiments, the low emissivity layer of the outside glass pane further comprises a photochromic activation threshold where the low emissivity layer transmits enough solar radiation in an activation band of the photochromic glass to enable solar radiation transmitted by the low emissivity layer of the outside glass pane in the direction of the inside glass pane to darken the photochromic glass and reduce visible light transmittance through the photochromic glass.

According to another embodiment of the present disclosure, the inside glass pane comprises an additional low emissivity layer such that the low emissivity layer of the outside glass pane and the additional low emissivity layer of the inside glass pane are positioned on opposite sides of the photochromic layer of the inside glass pane. In embodiments, the respective low emissivity layers comprise substantially different transmission characteristics within the activation band a of the photochromic glass, such that the low emissivity layer of the outside glass pane transmits a relatively high degree of solar radiation in the activation band a of the photochromic glass, while the additional low emissivity layer of the inside glass pane transmits a relatively low degree of radiation in the activation band a of the photochromic glass.

According to another embodiment of the present disclosure, the low emissivity layer of the outside glass pane absorbs solar radiation in the IR and near-IR bands and is provided in the thermally insulating space such that it is thermally insulated from the photochromic glass by the thermally insulating space.

According to another embodiment of the present disclosure, the low emissivity layer of the outside glass pane absorbs solar radiation in the IR and near-IR bands and is provided on the outside glass pane as the only low emissivity layer in the thermally insulating space.

According to another embodiment of the present disclosure, the photochromic glass of the inside glass pane is in direct thermal communication with the thermally insulating space between the inside and outside glass panes and is thermally insulated from the low emissivity layer by the thermally insulating space.

According to another embodiment of the present disclosure, a window comprising an outside glass pane and an inside glass pane is disclosed. In embodiments, the outside glass pane for interaction with outdoors comprises opposite surfaces and an outer edge and is formed from a first glass including a low emissivity layer. In embodiments, outside glass pane reflects light having a wavelength from about 701 nm to about 2,000 nm and transmits light having a wavelength from about 350 nm to about 700 nm. In embodiments, the inside glass pane for interaction with indoors comprises opposite surfaces and an outer edge and a photochromic glass. In embodiments, the inside glass pane is spaced apart from and disposed substantially parallel to the outside glass pane by a distance. In embodiments, light having a wavelength from about 350 to about 700 nm transmitted by the outside glass pane contacts the inside glass pane and darkens the photochromic glass.

According to another embodiment of the present disclosure, a window comprising an outside glass pane and an inside glass pane is disclosed. In embodiments, the outside glass pane for interaction with outdoors comprises opposite surfaces and an outer edge and is formed from a first glass. In embodiments, inside glass pane for interaction with indoors comprises opposite surfaces and an outer edge and a photochromic glass with a low emissivity layer. In embodiments, the inside glass pane is spaced apart from and disposed substantially parallel to the outside glass pane by a distance. In embodiments, the low emissivity layer reflects light having a wavelength from about 701 nm to about 2,000 nm and transmits light having a wavelength from about 350 nm to about 700 nm. In embodiments, light having a wavelength from about 350 to about 700 nm transmitted by the low emissivity layer contacts the inside glass pane and darkens the photochromic glass.

According to yet another embodiment of the present disclosure, a multi-pane window for a building is disclosed. In embodiments, the window comprises an outside glass pane adjacent the building exterior and an inside glass pane adjacent the building interior. In embodiments, the outside glass pane comprises first and second opposite surfaces and an outer edge and is formed from a first glass including a low emissivity layer. In embodiments, the outside glass pane reflects light from the building exterior having a wavelength from about 701 nm to about 2,000 nm and transmits light from the building exterior having a wavelength from about 350 nm to about 700 nm. In embodiments, the inside glass pane comprises first and second opposite surfaces and an outer edge and a photochromic glass as a laminate on a second glass. In embodiments, the inside glass pane is spaced apart from and disposed substantially parallel to the outside glass pane by a distance. In embodiments, light having a wavelength from about 350 to about 700 nm transmitted by the outside glass pane contacts the inside glass pane and darkens the photochromic glass.

According to another embodiment of the present disclosure, a building including a multi-pane window installed between and interior and exterior of the building is disclosed. In embodiments, the outside glass pane adjacent the building exterior comprises opposite surfaces and an outer edge and is formed from a first glass including a low emissivity layer. In embodiments, the outside glass pane reflects light from the building exterior having a wavelength from about 701 nm to about 2,000 nm and transmits light from the building exterior having a wavelength from about 350 nm to about 700 nm. In embodiments, the inside glass pane adjacent the building interior comprises opposite surfaces and an outer edge and a photochromic glass. In embodiments, the inside glass pane is spaced apart from and disposed substantially parallel to the outside glass pane by a distance. In embodiments, light having a wavelength from about 350 to about 700 nm transmitted by the outside glass pane contacts the inside glass pane and darkens the photochromic glass.

Methods of making window 100 are also disclosed herein. Methods of making window 100 include positioning outside glass pane 102 relative to inside glass pane 202 within a frame 420. In embodiments, frame 420 includes an overhanging edge portion configured to interfere with a portion of an edge of an opening in a building or enclosure and such that window 100 cannot be installed in the building or enclosure when outside glass pane 102 is adjacent the building interior.

Methods of installing window 100 are also disclosed herein. Methods of installing window 100 include arranging outside glass pane 102 relative to inside glass pane 202 in frame 420 such that outside glass pane 202 is adjacent an outdoor environment or building exterior and inside glass pane 102 is adjacent an indoor environment or building interior. Methods of installing window 100 may include positioning the outside glass pane adjacent to a building or enclosure exterior and the inside glass pane adjacent to a building or enclosure interior. Methods of installing window 100 may also include sealing window 100 within an opening of a building or enclosure. Methods of installing window may also include fixing inside glass pane and outside glass pane within frame 420.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of this disclosure may occur to persons skilled in the art, the present disclosure should be construed to include everything within the scope of the appended claims and their equivalents.

1. A window comprising:
an outside glass pane comprising opposite surfaces and a first outer edge, the outside glass pane formed from a first glass and includes a low emissivity layer; and
an inside glass pane comprising opposite surfaces and a second outer edge, the inside glass pane comprising a photochromic glass,
the inside glass pane is spaced apart from and disposed substantially parallel to the outside glass pane,
the outside glass pane transmits light in the visible portion of the optical spectrum,
the low emissivity layer blocks transmission of a portion of solar radiation in the IR and near-IR bands, and
wherein the low emissivity layer of the outside glass pane transmits an activation band to reduce visible light transmittance through the photochromic glass.

2. The window of claim 1 wherein a photochromic activation threshold of the low emissivity layer and the activation band of the photochromic glass are such that the inside glass pane darkens under indirect sunlight in less than about 7 minutes.

3. (canceled)

4. The window of claim 1 wherein the low emissivity layer blocks a portion of solar radiation at wavelengths above about 700 nm.

5. The window of claim 1 wherein the transmittance of the low emissivity layer progressively declines with increasing wavelength from above about 40% at a wavelength of about 700 nm to less than about 10% at a wavelength from about 700 nm and about 2000 nm.

6. (canceled)

7. The window of claim 1 wherein the low emissivity layer is at least about 30% transmissive to wavelengths in the activation band of the photochromic glass.

8. (canceled)

9. The window of claim 1 wherein:
the activation band a of the photochromic glass includes wavelengths from about 350 nm to about 420 nm; and
the low emissivity layer is at least about 30% transmissive in the activation band a of the photochromic glass.

10. (canceled)

11. The window of claim 1 wherein:
the inside glass pane is spaced apart from and disposed substantially parallel to the outside glass pane to define a thermally insulating space there between;
the thermally insulating space is either partially or fully evacuated, filled with a thermally insulating gas, or a combination thereof; and
the low emissivity layer of the outside glass pane absorbs solar radiation in the IR and near-IR bands and is provided in the thermally insulating space such that it is thermally insulated from the photochromic glass by the thermally insulating space.

12. The window of claim 1 wherein:
the inside glass pane is spaced apart from and disposed substantially parallel to the outside glass pane to define a thermally insulating space there between; and
the low emissivity layer of the outside glass pane absorbs solar radiation in the IR and near-IR bands and is provided on the outside glass pane as the only low emissivity layer in the thermally insulating space.

13. The window of claim 1 wherein:
the inside glass pane is spaced apart from and disposed substantially parallel to the outside glass pane to define a thermally insulating space there between;
the low emissivity layer of the outside glass pane absorbs solar radiation in the IR and near-IR bands and is provided on the outside glass pane in the thermally insulating space; and
the photochromic glass of the inside glass pane is in direct thermal communication with the thermally insulating space between the inside and outside glass panes and is thermally insulated from the low emissivity layer by the thermally insulating space.

14. The window of claim 1 wherein:
the inside glass pane comprises an additional low emissivity layer such that the low emissivity layer of the outside glass pane and the additional low emissivity layer of the inside glass pane are positioned on opposite sides of the photochromic layer of the inside glass pane;
the respective low emissivity layers comprise different transmission characteristics as a function of wavelength; and
the additional low emissivity layer is selected to minimize transmittance of wavelengths within the activation band a of the photochromic glass.

15. (canceled)

16. The of claim 1 wherein the low emissivity layer is a coating on one of the outside glass pane opposite surfaces, the coating having a thickness from about 50 nm to about 250 nm.

17. The window of claim 1 wherein a first distance between the outside and inside glass panes is from about 5 mm to about 25 mm.

18. The window of claim 1 wherein the inside glass pane further comprises a second glass as a laminate on the photochromic glass with an interface there between, wherein one surface of the inside glass pane is formed from the photochromic glass and the opposite surface of the inside glass pane is formed from the second glass.

19. The window as claimed in claim 18 further comprising a bonding interlayer at the laminate interface, wherein the boding interlayer is substantially transparent to visible light.

20. (canceled)

21. The window of claim 18 further comprising an additional low emissivity layer at the interface between the photochromic glass and the second glass.

22. The window of claim 21 wherein the additional low emissivity layer is selected to minimize transmittance of wavelengths within the activation band a of the photochromic glass.

23. The window of claim 1 further comprising a third glass pane,
wherein the third glass pane is spaced apart from and disposed substantially parallel to the outside glass pane by a second distance, and
wherein the third glass pane is spaced apart from and disposed substantially parallel to the inside glass pane by a third distance.

24. A window comprising an outside glass pane and an inside glass pane, wherein:
the outside glass pane comprises a low emissivity layer;
the inside glass comprises a photochromic glass;
the inside glass pane is spaced apart from and disposed substantially parallel to the outside glass pane;
the outside glass pane transmits light in the visible portion of the optical spectrum; and
the low emissivity layer of the outside glass pane transmits solar radiation in an activation band of the photochromic glass in the direction of the inside glass pane to darken the photochromic glass and reduce visible light transmittance through the photochromic glass.

25. The window of claim 24 wherein the inside glass pane comprises an additional low emissivity layer such that the low emissivity layer of the outside glass pane and the additional low emissivity layer of the inside glass pane are positioned on opposite sides of the photochromic glass.

26. The window of claim 25 wherein the respective low emissivity layers comprise different transmission characteristics within the activation band a of the photochromic glass, such that the low emissivity layer of the outside glass pane transmits a relatively high degree of solar radiation in the activation band a of the photochromic glass, while the additional low emissivity layer of the inside glass pane transmits a relatively low degree of radiation in the activation band a of the photochromic glass.

27. (canceled)

28. (canceled)
